(19) United States
(12) Patent Application Publication
(10) Pub. No.: US 2011/0111278 A1
(43) Pub. Date: May 12, 2011

(54) LOW THERMAL SPREAD BATTERY MODULE

(75) Inventors: Debashis Ghosh, Williamsville, NY (US); John R. Hambruch, Burt, NY (US)

(73) Assignee: DELPHI TECHNOLOGIES, INC., Troy, MI (US)

(21) Appl. No.: 12/616,846

(22) Filed: Nov. 12, 2009

(51) Int. Cl. H01M 10/50; H01M 6/42

(52) U.S. Cl. 429/120; 429/149

(57) ABSTRACT

A battery pack assembly having a casing enclosing stacks of cells. The casing defines a plurality of air intake chambers for receiving a flow of air and a plurality of slots diametrically opposite of the air intake chambers for dispensing the flow of air, and the air flows circumferentially through a gap around the cell walls to cool the cells. A plurality of circumferentially and radially spaced flow interrupters are disposed on at lest one of the cell wall and the casing for disrupting the flow of air to increase the heat transfer coefficient of that air.

### BACKGROUND OF THE INVENTION

1. Field of the Invention

The present invention relates to a battery pack assembly for providing electrical power.

2. Description of the Prior Art

It is well known to combine a number of stacks, each including a number of individual cells, for providing electrical power. Heat is generated as electrical current flows into and out of the cells. If the heat is not effectively managed, it can have a significant negative impact on the performance and lifetime of the cells and of the battery pack assembly as a whole. Limiting the temperature difference along the exterior of each of the cells in the stacks can be important in maximizing the performance and lifetime of the entire battery pack assembly.

To maintain the battery packs and the cells at a desired temperature, a cooling system is often provided within the battery pack assembly. Conventionally, these cooling systems pass air over and around the battery packs and the cells. In this type of system, the cooling air absorbs heat as it passes over the cells. Co-pending Delphi patent application docket number DP-316597 in the name of the same inventor herein, discloses a cooling system including an air inlet chamber and a slot. The air flows circumferentially around the walls of the cells from the air inlet chamber to the slot to cool the cells.

U.S. Patent Application No. 2007/0046259 to Hideo Shimizu discloses a battery pack assembly including a plurality of stacks and a casing enclosing the stacks. The gap between the slots of the casing and the cells of the stacks serially decreases as the air flows in series circumferentially along a plurality of stacks. The velocity of the flow of air increases as the gap between the casing and the cells decreases.

As the cooling air warms, its capacity to pick up heat decreases, thereby creating cooler temperatures near the air inlet chamber and warmer temperatures near the exit.

### SUMMARY OF THE INVENTION

The invention provides for such a battery pack assembly and including a plurality of flow interrupters disposed on either the cell wall or the plastic casing around the cell. The flow interrupters are circumferentially spaced from each other and extend radially in the gap between the cell wall and plastic casing to disrupt the flow of air from the air inlet chamber to the exit.

The primary function of the flow interrupters is to provide a boost to the heat transfer coefficient of the air thereby increasing the amount of heat transferred from the cells to the air adjacent those flow interrupters at low overall pressure drop penalty. In addition, they can also serve as weight bearing posts to support the weight of the cells and can act as spacers to maintain the gap between the cell wall and the plastic case to permit airflow.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a fragmentary perspective view of an embodiment of the invention;

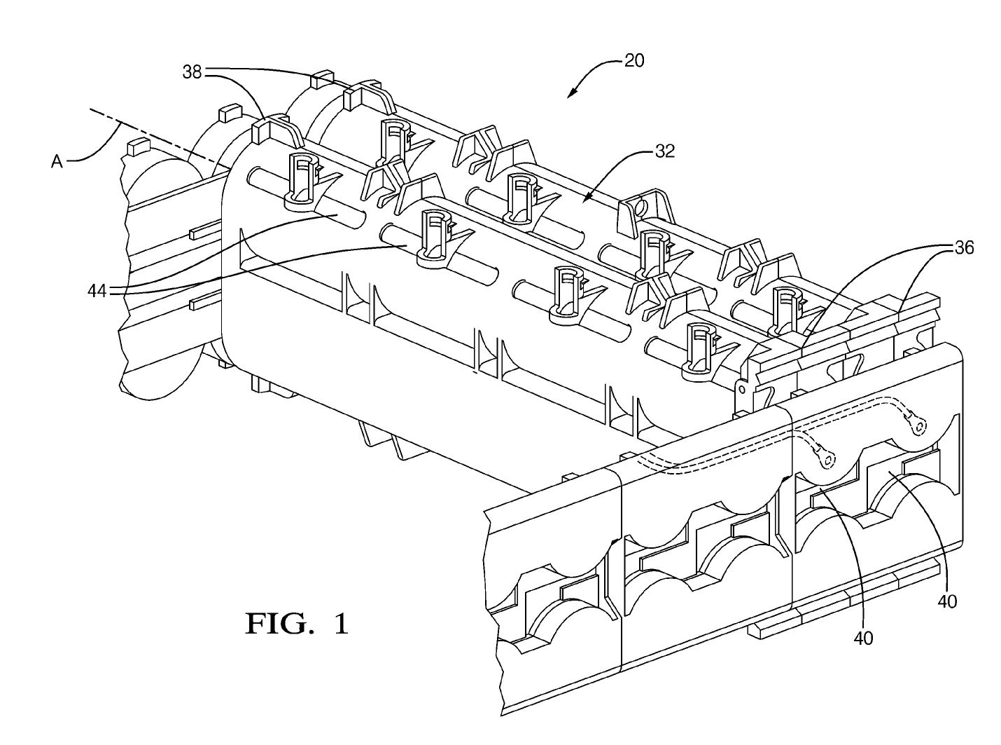

FIG. 2 is a perspective view and in partial cross-section of a pair of battery packs used in the embodiment of FIG. 1;

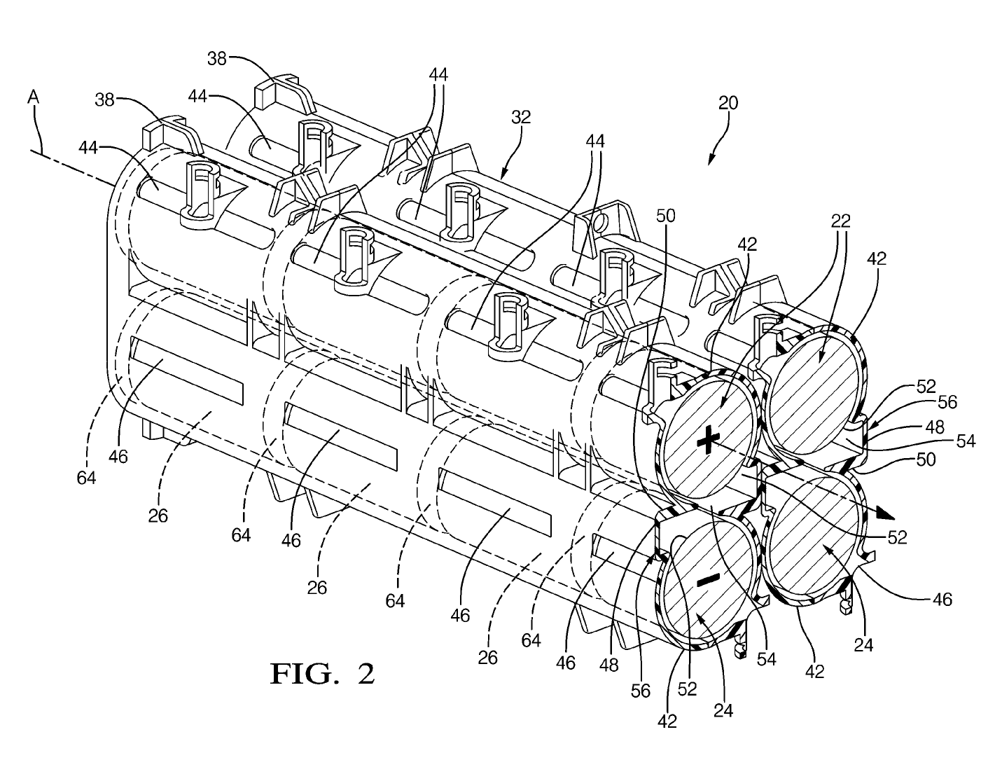

FIG. 3 is a fragmentary front perspective view of a first embodiment with half of the casing removed to show the cells;

FIG. 4 is a schematic view illustrating interruptors with varying gap between the cell walls and the upper and lower case;

FIG. 5 is a fragmentary front perspective view of a second embodiment with half of the casing removed to show the cells;

FIG. 6 is a fragmentary front perspective view of a third embodiment with half of the casing removed to show the cells; and

FIG. 7 is a cross-sectional view showing air flowing circumferentially along the cell wall from the air inlet chamber to the exit.

### DETAILED DESCRIPTION OF THE INVENTION

Referring to the Figures, wherein like numerals indicate corresponding parts throughout the several views, the invention includes a battery pack 20 assembly for providing electrical power.

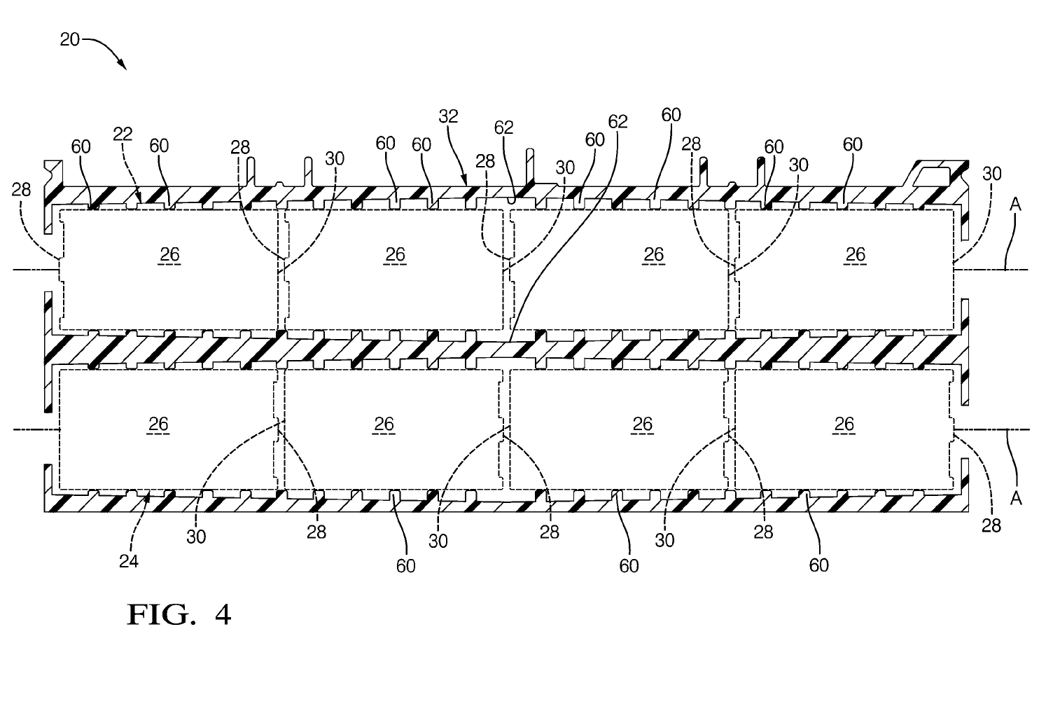

The battery pack assembly includes a battery pack 20, generally shown, including an upper stack 22 and a lower stack 24 extending in spaced and parallel relationship along a cell axis A. The battery pack 20 defines an air path extending along and between the stacks 22, 24 for cooling. Each of the stacks 22, 24 includes a plurality of cylindrical cells 26 for storing and transmitting electrical power, and each of the cells 26 has an anode 28 disposed at one end and a cathode 30 disposed at the other end. The cells 26 are arranged in cathode-to-anode relationship as is well known in the art. As such, the cells 26 of each of the stacks 22, 24 are connected to one another in electrical series connection. The anodes 28 of the cells 26 in the upper stack 22 face in one direction while the anodes 28 in the lower stack 24 face in the opposite direction, as is illustrated in FIG. 4.

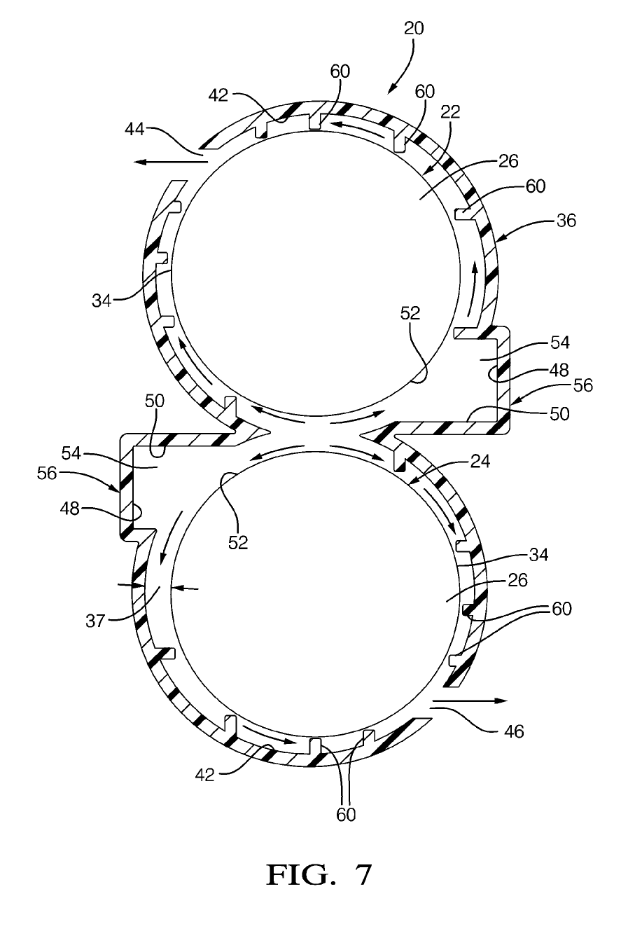

The battery pack 20 further includes a casing 32, generally indicated, nesting and enclosing the upper and lower stacks 22, 24 and having a front and a back. As best shown in FIG. 7, the battery pack 20 defines a gap 37 between the casing 32 and the cell walls 34 for air to flow therethrough. A front end cover 36 is disposed at the front of the battery pack 20 and a back end cover 38 is disposed at the back of the battery pack 20. The front and back end covers 36, 38 enclose the ends of the casing 32 and the front end cover 36 defines an air inlet 40 for receiving a flow of air. The casing 32 defines a semi-cylindrical section 42 extending circumferentially around the cell walls 34 of each of the upper and lower stacks 22, 24 and longitudinally along the cell axis A between the front and back of the casing 32.

The semi-cylindrical section 42 adjacent the upper stack 22 defines a plurality of upper slots 44 and the semi-cylindrical section 42 adjacent the lower stack 24 defines a plurality of lower slots 46. The upper and lower slots 44, 46 discharge the flow of air from the casing 32.

The casing 32 defines a plurality of reverse-L-shaped pieces 56, generally indicated, each having a long leg 48 extending tangentially from one of the semi-cylindrical sections 42 to a short leg 50 extending transversely and spaced from a remainder portion 52 of the stack for creating an enclosed space around the perimeter of each of the stacks 22, 24 to define an air inlet chamber 54 extending axially from the air inlet 40 of the front end cover 36 to the closed back end cover 38. Each of the air inlet chambers 54 is defined by the long leg 48 and the short leg 50 and the cylindrical cell walls 34 of the remainder portion 52 of the associated stack. The air inlet chambers 54 are in fluid communication with the air inlet 40 of the front cover to receive the flow of air therefrom. The semi-cylindrical sections 42 and the reverse-L-shaped pieces 56 of the casing 32 combine to completely enclose the upper and lower stacks 22, 24.

In operation, the flow of air enters the casing 32 through the air inlet 40 of the front end cover 36. The flow of air then flows axially through the air inlet chamber 54 and circumferentially through the gaps 37 between the cell walls 34 and the casing 32 to be discharged through the upper and lower slots 44, 46 of the casing 32.

A plurality of flow interrupters 60 are disposed on either the cell walls 34 or the casing 32. The flow interrupters 60 are circumferentially spaced from each other and extend into the gap 37 toward the other of the cell walls 34 and the casing 32 for disrupting the flow of air from the air inlet chambers 54 to the upper and lower slots 44, 46. In other words, as the flow of air travels circumferentially along the cell 26 from the air inlet chamber 54 to the associated one of the upper and lower slots 44, 46, it is disrupted by the flow interrupters 60 to provide a boost in the heat transfer coefficient of the air and thus increase the amount of heat transferred from the cells 26 to the air adjacent those flow interrupters 60.

The flow interrupters 60 are spaced a predetermined distance from each other with the distance being greater adjacent the air inlet chamber 54, which is the remainder portion 52 of the cells 26, and serially decreasing circumferentially to the upper and lower slots 44, 46. The flow interrupters 60 are close together adjacent the upper and lower slots 44, 46 because the air is the warmest at those locations. Having a decreased distance between flow interrupters 60 increases the rate of heat transfer to the warmer air, thereby providing a more even cooling rate across the cell walls 34. In other words, the variable spacing between the flow interrupters 60 along the circumference of the stacks 22, 24 allows the flow of air to cool the cells 26 at a more even rate across the circumference of the cell walls 34. The flow interrupters 60 work more efficiently if made integral to the cell wall 34. However, sometimes due to OEM constraints, no enhancement to the cell wall 34 is possible, and one has to live with a flat cell wall surface 34. In that case, the flow interrupters 60 are molded onto the plastic case 32.

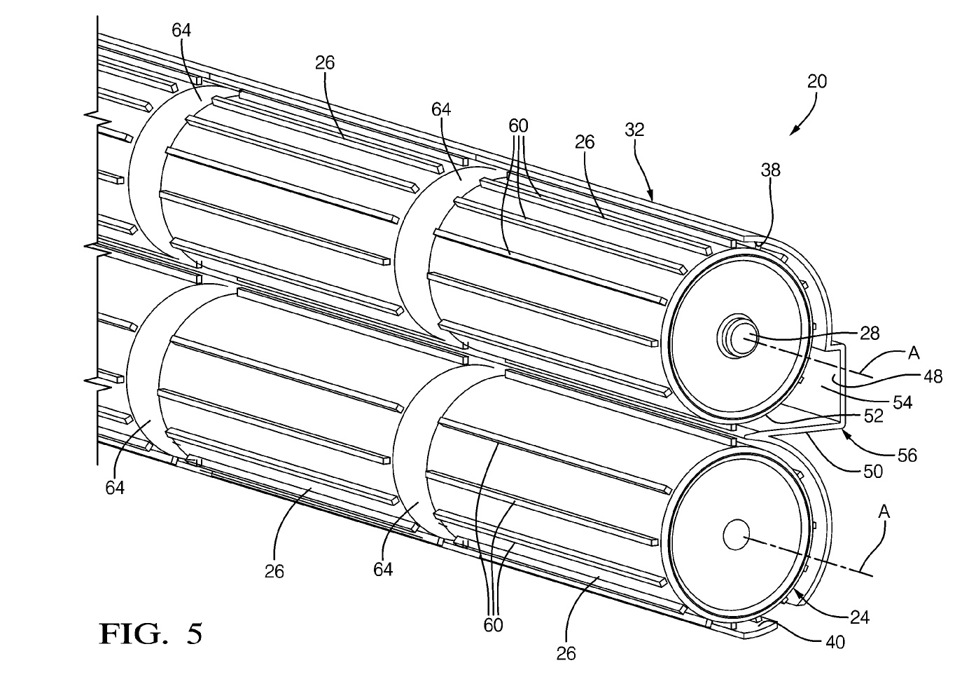

FIG. 5 shows a first embodiment of the invention. Each of the flow interrupters 60 of the first embodiment extends radially from the cell wall 34 to a point in the gap 37 between the associated cell wall 34 and the casing 32. A spacer 64 is disposed between adjacent cells 26 of the upper and lower stacks 22, 24. The spacer 64 extends radially outwardly from the cells 26 to engage the casing 32 for positioning, insulating and orienting the cell 26. The spacer 64 is preferably made of an insulating material, e.g. rubber, to prevent electrical conduction between the cells 26.

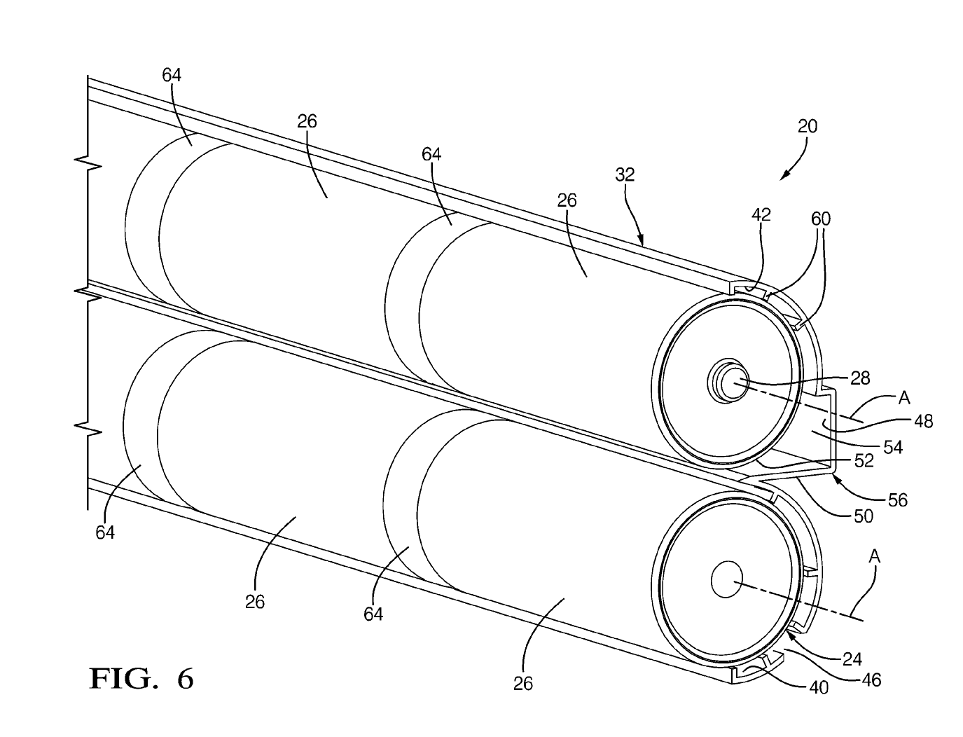

FIG. 6 shows a third embodiment of the invention. Each of the flow interrupters 60 extends radially from the casing 32 to a point in the gap 37 between the casing 32 and the cell walls 34. Similar to the first embodiment described above, a spacer 64 is disposed between adjacent cells 26 of the upper and lower stacks 22, 24. The spacer 64 extends radially outwardly from the cells 26 to engage the casing 32 for positioning and orienting each of the cells 26.

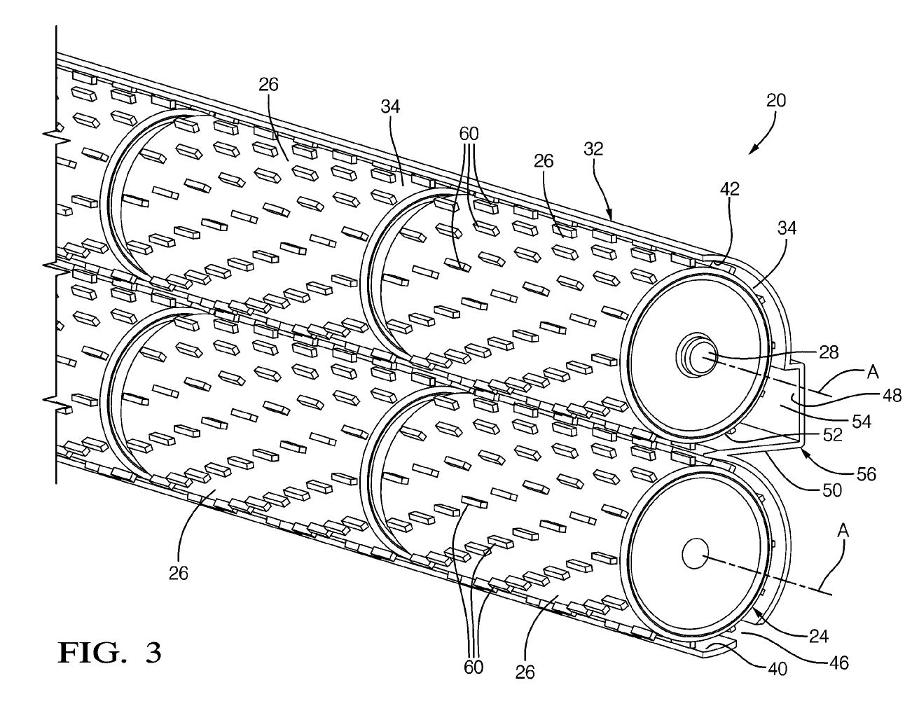

The flow interrupters 60 can be all in line, as shown in FIG. 5, or they can be staggered circumferentially, as shown in FIG. 3. If the height of the flow interrupters 60 are less than the gap 37 height, then the flow interrupters 60 can be made in line. However, if the flow interrupter 60 height is equal to the gap 37 height, then inline arrangement would completely choke the flow; in that case, the circumferentially staggered arrangement of flow interrupters 60, as shown in FIG. 3, is needed. The staggered arrangement of the flow interrupters 60 enhances heat dissipation by the cells 26 with lower pressure drop.

FIGS. 3 and 4 show a third embodiment of the invention. Each of the flow interrupters 60 extends radially from the casing 32 into the gap 37 between the cell wall 34 and the casing 32. In addition to disrupting the flow of air as described above, the flow interrupters 60 of the first embodiment function to support the weight of the cells 26 by the case and maintain the relative position of the cells 26 with in the casing 32. In this configuration the need for a spacer 64 is eliminated. This offers significant cooling advantage as the spacers 64 of the first and second embodiments cover 10-15% of the surface area of each of the cells 26. Additionally, removing the spacers 64 exposes the cathode 30 and part of the anode 28 of each of the cells 26 to the flow of air. Heat is transferred from cathodes 30 and anodes 28 of the cells 26, to the air very efficiently.

Each of the gaps 37 may have a cross-section that varies in size. For example, as shown in FIG. 4, the cross-section of the gaps 37 increases from the front to a larger midpoint 62 and increases from the back to the larger midpoint 62. The height of the flow interrupters 60 varies to correspond with the varying gap 37.

In the third embodiment of FIGS. 3 and 4, all the cells 26 in each of the stacks 22, 24, in this case four, are wrapped around by a mylar film (not shown) to hold them together. Additionally, all of the upper slots 44 can be combined and all of the lower slots 46 can be combined into a single continuous slot of varying opening.

FIG. 7 shows a cross-section of a fourth embodiment. In this embodiment, the spacers 64 are not totally eliminated, however, some of the weight of the cells 26 is supported by the flow interrupters 60 disposed beneath each of the stacks 22, 24. Supporting the weight of the stacks 22, 24 with the flow interrupters 60 significantly reduces the required width of the spacer 64. The additional surface area exposed for heat transfer due to the thinner spacers 64 keep also improves the efficiency of the cooling of the cells 26. In other words, all the flow interruptors do not fill the entire height of the gap 37 between the cell 26 and the plastic. Only, the weight bearing interrupters at the bottom of each of the stacks 22, 24 run the entire height of the gap 37. The weight bearing flow interrupters 60 are made thicker in cross section than the rest for strength. The rest of the flow interrupters 60 molded circumferentially only extend partially into the gap 37.

As seen in FIG. 7, the flow interrupters 60 of the fourth embodiment extend horizontally or vertically into the gap 37 as opposed to radially in the first three embodiments. Having flow interrupters 60 disposed only horizontally or vertically as opposed to being radial facilitates injection molding the plastic casing 32.

Flow interrupters 60 of the above embodiments are ribs placed perpendicular to the air stream to interrupt the flow and thus enhance heat transfer by increasing the local heat transfer coefficient of cooling air. The flow interrupters 60 can be employed in ways, built on the cell wall 34 (best shown in FIG. 5) or on the casing 32 (best shown in FIG. 6). They are radial extensions that can run as single rib along the full length of a cell 26 (shown in FIGS. 5 and 6) or multiple ribs spanning a portion of the length of each cell 26 (shown in FIGS. 3 and 4).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A battery pack assembly for providing electrical power comprising:
a battery pack including an upper stack extending along a cell axis (A) and including at least one cell and defining an air path for cooling;
each of said cells having a cell wall;
said battery pack including a casing having a front and a back and enclosing said upper stack and defining an air inlet chamber for receiving a flow of air and an upper slot for dispensing the flow of air; and
a plurality of flow interrupters disposed on at least one of said cell wall and said casing and being circumferentially spaced from each other and extending toward the other of said cell wall and said casing for disrupting the flow of air from said air inlet chamber to said upper slot.

2. The assembly as set forth in claim 1 wherein said battery pack defines a gap between said cell wall and said casing for channeling the flow of air therethrough.

3. The assembly as set forth in claim 2 wherein said gap has a cross-section increasing in size from said front to a larger midpoint and increasing in size from said back to said larger midpoint.

4. The assembly as set forth in claim 2 wherein at least one of said flow interrupters extends from said casing into said gap to engage said cell wall.

5. The assembly as set forth in claim 4 wherein each of said plurality of flow interrupters extends from said casing into said gap to engage said cell wall.

6. The assembly as set forth in claim 1 wherein said slot is disposed diametrically opposite said air inlet chamber.

7. The assembly as set forth in claim 1 wherein said battery pack further includes a lower stack.

8. The assembly as set forth in claim 7 wherein said upper and lower stacks of said battery pack extend in side by side and parallel relationship.

9. The assembly as set forth in claim 8 wherein each of said upper and lower stacks includes a plurality of cells for storing and transmitting electrical power.

10. The assembly as set forth in claim 9 wherein said casing defines a semi-cylindrical section extending circumferentially about each of said upper and lower stacks and longitudinally along said cell axis between said front and back of said casing.

11. The assembly as set forth in claim 10 wherein said casing defines a plurality of reverse-L-shaped pieces with each reverse-L-shaped piece having a long leg extending tangentially from one of said semi-cylindrical sections to a short leg extending transversely and spaced from a remainder portion of said stack for creating an enclosed space around the perimeter of said stack to define said air inlet chamber.

12. The assembly as set forth in claim 11 wherein said semi-cylindrical sections and said reverse-L-shaped pieces of said casing combine to enclose said upper and lower stacks.

13. The assembly as set forth in claim 12 wherein said air inlet chamber is further defined by said long leg and said short leg and said cell walls of said remainder portion of the associated one of said upper and lower stacks.

14. The assembly as set forth in claim 1 wherein said upper stack extends along a cell axis and includes a plurality of cells for storing and transmitting electrical power.

15. The assembly as set forth in claim 14 further including a spacer disposed between adjacent cells of said upper stack and extending radially outwardly to engage said casing for positioning and orienting said upper stack in said casing.

16. The assembly as set forth in claim 15 wherein said spacer is of an insulating material.

17. The assembly as set forth in claim 16 wherein said spacer wraps around said cell wall.

18. The assembly as set forth in claim 1 wherein said cell wall defines a cylinder.

19. The assembly as set forth in claim 1 wherein said flow interrupters are spaced a predetermined distance from each other with said predetermined distance being greater adjacent said air inlet chamber than adjacent the associated one of said upper and lower slots.

20. The assembly as set forth in claim 19 wherein said predetermined distance between said flow interrupters serially decreases from said flow interrupters adjacent said air inlet chamber to said flow interrupters adjacent said upper slot.

21. A battery pack assembly for providing electrical power comprising:
a battery pack including an upper stack and a lower stack extending parallel to one another and disposed in a side by side relationship and defining an air path therethrough for cooling;
each of said stacks extending along a cell axis and including a plurality of cells for storing and transmitting electrical power;
each of said cells having a cell wall defining a cylinder;
each of said air paths including an air inlet chamber extending the length of said respective battery pack and being defined on one side by said cylindrical cell walls for receiving a flow of air to supply the air to said cells;
said battery pack including a casing having a front and a back and nesting and enclosing said upper and lower stacks;
said battery pack defining a gap between said cell walls and said casing;
said casing defining a semi-cylindrical section extending circumferentially about said cell walls of said upper and lower stacks and longitudinally along said cell axis between said front and back of said casing;
said casing defining a plurality of reverse-L-shaped pieces with each reverse-L-shaped piece having a long leg extending tangentially from one of said semi-cylindrical sections to a short leg extending transversely and spaced from a remainder portion of the associated stack;
said semi-cylindrical sections and said reverse-L-shaped pieces of said casing combining to enclose said upper and lower stacks;
each of said air inlet chambers being defined by said long leg and said short leg of said reverse-L-shaped piece and said cell walls of said remainder portion of the associated stack;
said casing defining a plurality of upper slots diametrically opposite of said air inlet chamber adjacent said upper stack and a plurality of lower slots diametrically opposite said air inlet chamber adjacent said lower stack;
a plurality of flow interrupters disposed on at least one of said cell walls of said upper and lower stacks and said casing and being circumferentially spaced from each other and extending radially toward the other of said cell walls and said casing for disrupting the flow of air from each air inlet chamber to the associated one of said upper and lower slots; and
said flow interrupters being spaced a predetermined distance from each other with said distance being greater adjacent said air inlet chamber and serially decreasing to the associated one of said upper and lower slots.

22. The assembly as set forth in claim 21 wherein each of said flow interrupters extends radially across said gap between said cell walls and said casing.

23. The assembly as set forth in claim 22 wherein each of said gaps between said stacks and said casing has a cross-section increasing in size from said front to a larger midpoint and increasing in size from said back to said larger midpoint.

24. The assembly as set forth in claim 21 further including a spacer disposed between adjacent cells of said upper and lower stacks and extending radially outwardly to engage said casing and said spacer being made of an insulating material and wrapping around said cell wall for positioning and orienting said cell in said associated slot.
